(19) United States
(12) Patent Application Publication
(10) Pub. No.: US 2014/0122758 A1
(43) Pub. Date: May 1, 2014

(54) METHOD AND DEVICE FOR PARAMETERIZING AN AS-I SLAVE

(71) Applicant: Andreas Macher, Neumarkt (DE)

(72) Inventor: Andreas Macher, Neumarkt (DE)

(73) Assignee: SIEMENS AKTIENGESELLSCHAFT, Munich (DE)

(21) Appl. No.: 14/117,063

(22) PCT Filed: May 20, 2011
(86) PCT No.: PCT/EP11/58278

§ 371 Date: Nov. 12, 2013

(51) Int. Cl. G06F 13/36

(52) U.S. Cl. CPC G06F 13/36
USPC 710/110

(57) ABSTRACT

A method is disclosed for parameterizing an AS-i slave. In order to improve the parameterization of an AS-i slave, the following steps are carried out: determining the parameters of the AS-i slave to be parameterized via an engineering tool; transmitting the determined parameters to an AS-i master via a first telegram; receiving the first telegram, which contains the determined parameters of the AS-i slave to be parameterized, via a receiving unit of the AS-i master; automatically converting the received first telegram into an AS-i telegram by a processing unit of the AS-i master, such that the AS-i telegram contains the determined parameters of the AS-i slave to be parameterized; and transmitting the AS-i telegram, which contains the determined parameters of the AS-i slave to be parameterized, to the AS-i slave to be parameterized via a transmission unit of the AS-i master.

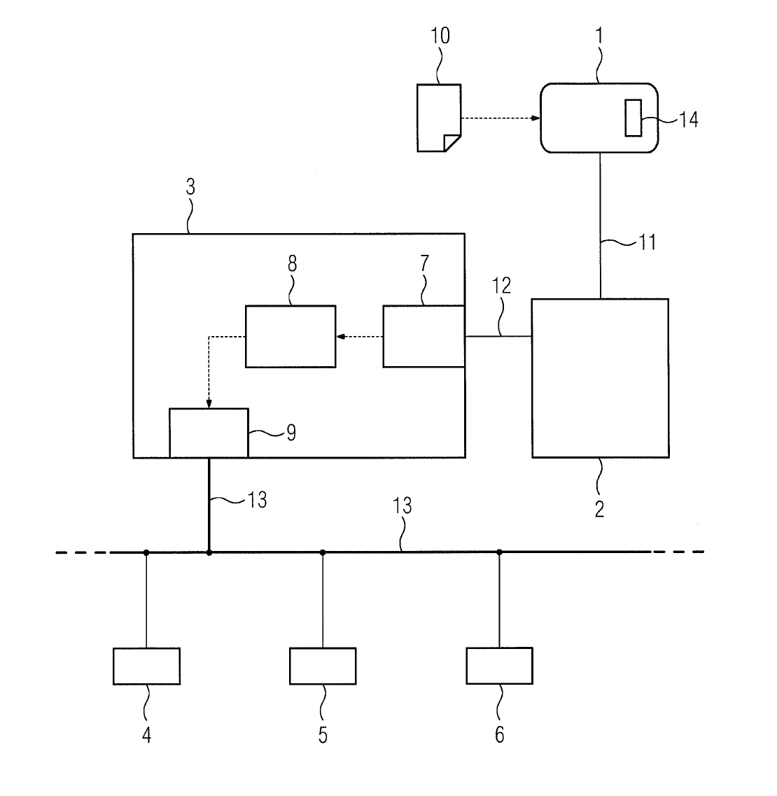

### PRIORITY STATEMENT

This application is the national phase under 35 U.S.C. §371 of PCT International Application No. PCT/EP2011/058278 which has an International filing date of May 20, 2011, which designated the United States of America, the entire contents of each of which are hereby incorporated herein by reference.

### FIELD

At least one embodiment of the present invention generally relates to a method for parameterizing one or a number of AS-i slaves. Furthermore, at least one embodiment of the invention generally relates to an AS-i master, by which an AS-i slave or a number of AS-i slaves can be parameterized.

### BACKGROUND

In the field of industrial automation technology, AS interface (Actuator Sensor interface, AS-i) is used for communication between individual devices of a system on the lowest field bus plane. AS-interface forms a standard for the field bus communication, in which actuators and sensors (AS-i slaves) are in particular connected to a controller. AS-interface is a single-master system, i.e. an AS-i master cyclically polls all projected AS-i slaves and exchanges the input and output data therewith. A telegram consists here of 4 bit payload data. The AS-i master communicates with a serial transmission protocol with the individual AS-i slaves.

Since devices of the actuator/sensor plane are becoming increasingly more intelligent, this results in a greater demand for parameters to by set by the user on these devices. If a user would like to parameterize an AS-i slave connected to his AS-i master, he must currently prepare the parameters to be transmitted to the AS-i slave by way of a program to be written by a user such that a prefabricated AS-i telegram is sent to the AS-i master, in which the parameters for the AS-i slave are stored such that the AS-i master only has to forward this AS-i telegram to the relevant slave. In other words, the AS-i master must already be provided with the pass-through AS-i telegram by the user, said AS-I telegram containing the parameters of the slave. There is no change in the AS-i telegram sent by the user within the AS-master. Depending on the AS-i slave to be parameterized, the user must prepare a corresponding AS-i telegram so that the AS-i master is able to pass through this 1:1. This procedure is extremely complex for the user since it has to generate different AS-i telegrams for the individual AS-i slaves.

### SUMMARY

At least one embodiment of the present invention is directed to improving the parameterization of an AS-i slave.

At least one embodiment is directed to a method for parameterizing an AS-i slave comprising:

Determining the parameters of the AS-i slave to be parameterized by way of an engineering tool,

Transmitting the determined parameters to an AS-i master by way of a first telegram,

Receiving the first telegram, which contains the determined parameters of the AS-i slave to be parameterized, by way of a receive unit of the AS-i master,

Automatically converting the received first telegram into an AS-i telegram by way of a processing unit of the AS-i master, so that the AS-i telegram contains the determined parameters of the AS-i slave to be parameterized,

Sending the AS-i telegram, which contains the determined parameters of the AS-i slave to be parameterized, to the AS-i slave to be parameterized by way of a send unit of the AS-i master,

and a device as claimed in claim 11, i.e. by an AS-i master with a receive unit, which can receive a first telegram, which contains parameters for an AS-i slave to be parameterized, a processing unit, which can automatically convert the received first telegram into an AS-i telegram so that the AS-i telegram contains the parameters of the AS-i slave to be parameterized and a send unit, which can send the AS-i telegram, which contains the parameters of the AS-I slave to be parameterized, to the AS-i slave to be parameterized.

Advantageous developments of the invention are specified in the dependent claims.

### BRIEF DESCRIPTION OF THE DRAWINGS

The invention and embodiment of the invention is described and explained in more detail with the aid of the example embodiment shown in the FIGURE.

The FIGURE shows the schematic structure of a part of an industrial system. Within this system, a first AS-i slave 4, a second AS-i slave 5 and a third AS-i slave 6 are connected to an AS-i master 3 by way of an AS-i bus 13. The communication between the AS-i master 3 and the first, second and third AS-i slave 4, 5, 6 takes place by way of AS-interface. The AS-i master 3 herefor comprise a send unit 9, which is connected to the AS-i bus 13, so that it can communicate with the first, second and third AS-i slave 4, 5, 6. The AS-i master 3 is thus connected on the output side to the AS-i bus 13.

### DETAILED DESCRIPTION OF THE EXAMPLE EMBODIMENTS

An advantage achieved with an embodiment of the invention resides in the AS-i master for the user enabling a simplified parameterization of an AS-i slave. As a result of the first telegram, which likewise contains these parameters for the AS-i slave, being automatically converted by the AS-I master into an AS-i telegram, by way of the AS-i master, the parameterization of the AS-i slave can be significantly simplified for the user. This is achieved in particular such that it need not identify the telegram structure of the AS-i slave to be parameterized. The distribution to the corresponding AS-i slave now takes place automatically by way of the AS-i master, since this automatically converts the receiving first telegram, which contains parameters of the AS-i slave to be parameterized, into an AS-i telegram which likewise contains the parameters of the AS-i slave to be parameterized.

Since an automatic conversion of the parameters of the first telegram into the AS-i telegram takes place by way of the processing unit of the AS-i master, only the AS-i master has to be provided by the user with the parameters of the AS-i slave by way of the first telegram. As soon as the parameters of the AS-i slaves to be parameterized are available to the AS-master, it automatically sends these via the AS-i telegram to the relevant AS-i slave. A uniform communication interface for parameterization of an AS-i slave can thus be created, in which only the parameters of the AS-i slave to be parameterized have to be provided to the AS-i master.

With the transmission of the determined parameters to the AS-i master, a communication link is established between the engineering tool and the AS-i master. The communication link may be for instance a direct connection between the engineering tool and the AS-i master. Similarly, it is conceivable for a communication link to take place so as to transmit the determined parameters to the AS-i master by way of an interconnected controller. The controller is herewith connected to the engineering tool, so that the determined parameters are firstly sent by the engineering tool to the controller. The controller thereupon forwards the determined parameters to the AS-i master via a communication link between the controller and the AS-i master (e.g. PROFINET, PROFIBUS) so that the determined parameters of the AS-i slave to be parameterized are available to the AS-i master. The determined parameters of the AS-i slave to be parameterized are thus sent by way of a first telegram to the AS-i master. The first telegram is in particular not an AS-i telegram. The first telegram is preferably transmitted by way of Ethernet, PROFIBUS and/or PROFINET.

Since the parameters of the AS-i slave to be parameterized are available to the AS-i master, the first telegram is converted into an AS-i telegram by way of the AS-i master. The determined parameters transferred by the first telegram are herewith automatically converted by the AS-i master into an AS-i telegram which is determined for the AS-i slave to be parameterized. Since the first telegram is not an AS-i telegram, the processing unit must effect a conversion of the first telegram into the AS-i telegram.

When converting the first telegram into the AS-telegram by way of the processing unit of the AS-i master, the first telegram is preferably converted into a CTT AS-i telegram (CTT=Combined Transaction Types). The CTT1 and/or CTT2 telegram is preferably used to transmit the parameters from the AS-i master to the AS-i slave. Consequently following the conversion, the AS-i telegram contains the determined parameters of the slave to be parameterized.

The transmission of the As-i telegram and/or first telegram is not restricted to a communication cycle between the participating devices. As a function of the data size of the parameters to be transmitted, a number of communication cycles can similarly be required per telegram. An AS-i telegram, which contains specific parameters, can thus likewise be transmitted by way of a number of communication cycles between the AS-i master and the AS-i slave. Similarly, the transmission of the parameters of an AS-i slave to be parameterized from the engineering tool to the AS-i master can take place through a number of communication cycles between the As-i master and the engineering tool. The transmission of the first telegram or AS-i telegram can thus take place by way of a communication cycle between the participating devices but also by way of a number (>2) of communication cycles.

The AS-i master and in particular its processing unit includes a corresponding algorithm, which can convert the incoming first telegram in the receive unit, the telegram containing the determined parameters of the AS-i slave, into the AS-i telegram output on the output side by the send unit, said AS-i telegram likewise containing the determined parameters of the AS-i slave. A transformation of the first telegram into the AS-i telegram thus takes place by way of the AS-i master, so that the parameters of the AS-i slave are mapped in the AS-i telegram. The processing unit of the AS-i master is thus embodied such that it enables a conversion of a first telegram available on the input side into an AS-i telegram, wherein the first telegram differs from the AS-i telegram.

An advantage of the conversion in the AS-i master resides in the first telegram present on the input side, which contains the parameters for the AS-i slave, still not having to be prepared for the communication between the AS-i master and the AS-i slave. The “translation” into the AS-i telegram takes place automatically by the processing unit of the AS-i master. In order to parameterize the AS-i slave, a uniform protocol can thus be used to transmit the first telegram between the As-i master and the controller and/or the engineering tool. The conversion of the determined parameters into the AS-i telegram takes place automatically by way of the AS-i master.

For the parameterization of AS-i slaves, the existing communication between the AS-i master and the controller and/or the engineering tool can thus be used, so that a slave-specific preparation of the parameter data can be omitted.

In an advantageous embodiment of the invention, the AS-i slave to be parameterized receives the AS-i telegram and parameterizes itself by way of the specific parameters of the receiving AS-i telegram.

In a further advantageous embodiment of the invention, a parameter set of the AS-i slave to be parameterized is loaded by way of the engineering tool in order to determine the parameters of the AS-i slave to be parameterized.

In a further advantageous embodiment of the invention, parameter sets of different AS-i slaves are stored in the engineering tool, wherein the loaded parameter set is a parameter set of the stored parameter sets. The associated parameter sets for a number of slaves are thus stored in the engineering tool. By selecting the corresponding slave by way of the engineering tool, a user can thus load the parameter set of the relevant slave in the engineering tool so that it does not have to enter this. The parameter set of the respective slave includes in particular fixed parameters and/or variable parameters of the respective slave. The user can thus determine the parameters of the AS-i slave to be parameterized with the aid of the slave-specific loaded parameter set of the AS-i slave to be parameterized. If only fixed parameters are available in the parameter set, the user is not able to implement any further settings so that the parameters of the slave to be parameterized are already determined. If by contrast variable parameters are available, the user can for instance achieve a targeted selection of the relevant variable parameters in respect of the existing application. It can define value ranges for instance or assign a specific value.

In a further advantageous embodiment of the invention, a device description file of the AS-i slave to be parameterized is loaded in order to determine the parameters of the AS-i slave to be parameterized by way of the engineering tool, wherein the device description file includes the parameter set of the slave to be parameterized. The loading of the device description file can preferably take place by way of a data memory (e.g. via the internet) or an external storage medium. The parameter set stored in the device description file includes fixed parameters and/or variable parameters of the slave to be mapped. If only fixed parameters are available, the user must not undertake any inputting. If variable parameters exist, an inputting by the user is required in order to determine the parameters to be transmitted to the AS-i slave. The slave-specific parameter sets of the device description file can preferably be changed at least partially within the engineering tool.

In a further advantageous embodiment of the invention, the loaded parameter set of the AS-i slave to be parameterized is modified by way of the engineering tool in order to determine the parameters of the AS-i slave to be parameterized. The loaded parameter set of the respective slave includes in particular fixed parameters and/or variable parameters. If variable parameters are available, the user must define the variable parameters in respect of an existing application scenario by way of the engineering tool after loading the parameter set. The variable parameters to be transmitted are thus defined by the user and thus determined. During modification, the user can thus at least partly change the parameters of the AS-i slave to be parameterized. It can determine different value ranges of variable parameters of the AS-i slave to be parameterized for instance.

In a further advantageous embodiment of the invention, the AS-i slave emits a fault signal, provided the determined parameters transmitted by the AS-i telegram are faulty. This fault signal is sent to the AS-i master and preferably routed to the controller and/or to the engineering tool. The AS-i master, the controller and/or the engineering tool can thus output a warning signal (e.g. by way of an optical display) on the basis of the fault signal.

In a further advantageous embodiment of the invention, the determined parameters of the AS-i slave are stored in the AS-i master. In the case of a defect or replacement of an AS-i slave connected to the AS-i master, the already determined parameters of the defective or replaced AS-i slave can subsequently be sent automatically to the new and/or repaired AS-i slave without a renewed parameterization having to take place by way of the engineering tool. Provided the engineering tool has sent the parameters determined for the AS-i slave by way of a controller to the AS-i master, it is likewise conceivable for the parameters to be stored in addition to or solely in the controller so that in the case of a defect/replacement of the AS-i slave, the determined parameters are sent by way of the controller via the AS-i master to the AS-i slave.

In a further advantageous embodiment, the AS-i master checks whether the received parameters of the AS-i slave to be parameterized correspond to the AS-i slave to be parameterized which is connected to the AS-i master. An analysis in respect of the parameters of the AS-i slave to be parameterized takes place in particular in the AS-i master in respect of the information relating to the AS-i slave which is already available to the AS-i master by way of the AS-i communication. The AS-i master is in particular embodied such that it can check whether the received parameters of the AS-i slave to be parameterized correspond to the AS-i slave to be parameterized.

In a further advantageous embodiment of the invention, parameters of the at least two AS-i slaves to be parameterized are determined by way of the engineering tool and the determined parameters of the at least two AS-i slaves to be parameterized are transmitted to the AS-i master by way of the first telegram. The processing unit of the AS-i master thereupon converts the received first telegram automatically into an AS-i telegram for the respective AS-i slave to be parameterized so that the respective AS-i telegram contains the determined parameters of the AS-i slave to be parameterized. The send unit of the AS-i master sends the AS-i telegram to the at least two slaves to be parameterized, said AS-i telegram containing the determined parameters of the respective AS-i slave.

In a further advantageous embodiment of the invention, the AS-i master with the receive unit can receive a first telegram which contains parameters for at least two AS-i slaves to be parameterized, and thereupon automatically convert the received first telegram into an AS-i telegram for the respective AS-i slave to be parameterized so that the respective AS-i telegram contains the determined parameters of the AS-i slave to be parameterized. The send unit of the AS-i master can thus send the AS-i telegram to the at least two slaves to be parameterized respectively, said AS-I telegram containing the determined parameters of the respective AS-i slave. A “parameter packet” which can be sent from the engineering tool to the AS-i master is thus executed. The parameter packet can thus contain the parameters of a number of slaves to be parameterized and are sent from the engineering tool to the AS-i master. In particular, once the AS-i master has received the parameter packet, it can convert this into the corresponding AS-i telegram of the AS-i slaves to be parameterized so that these can be parameterized. The parameters of the AS-i slaves to be parameterized can thus be determined in the engineering tool and this data can be transmitted by way of the first telegram in a step to the AS-i master. The AS-i master can thereupon trigger the parameterization of the individual AS-i slaves.

In a further advantageous embodiment of the invention, a system exists which includes an engineering tool and an AS-i master, wherein the engineering tool is embodied such that parameters of the AS-i slaves to be parameterized can be determined by way of the engineering tool and transmitted to the AS-i master by way of a first telegram.

The parameters to be transmitted of an AS-i slave to be parameterized preferably comprise a data size of greater than 4 bits.

The FIGURE shows the schematic structure of a part of an industrial system. Within this system, a first AS-i slave 4, a second AS-i slave 5 and a third AS-i slave 6 are connected to an AS-i master 3 by way of an AS-i bus 13. The communication between the AS-i master 3 and the first, second and third AS-i slave 4, 5, 6 takes place by way of AS-interface. The AS-i master 3 herefor comprise a send unit 9, which is connected to the AS-i bus 13, so that it can communicate with the first, second and third AS-i slave 4, 5, 6. The AS-i master 3 is thus connected on the output side to the AS-i bus 13.

The AS-i master 3 is connected on the input side to a controller 2 (e.g. PLC) by way of a second communication link 12. The AS-i master 3 can thus communicate with the controller 2 by way of the second communication link 12. Data can thus be exchanged between both devices 2, 3 by way of a first telegram. In order to transmit the data between the controller 2 and the AS-i master 3, different communication methods (e.g. PROFINET, PROFIBUS, Industrial Ethernet) can be used. If the controller 2 is connected to the AS-i master 3 by way of PROFINET, the first telegram would be at least a PROFINET telegram. In order to receive the first telegram from the controller 2, the AS-i master 3 comprises a receive unit 7 on the output side. In the event of PROFINET, the second communication link 12 and thus the PROFINET cable is thus connected to the receive unit 7, so that data can be exchanged between the AS-i master 3 and the controller 2 by way of PROFINET.

If the second AS-i slave 5 has now subsequently been connected to the AS-i bus 13 for instance, this must firstly be parameterized by the user so that the “new” AS-i slave 5 is set in a system-specific manner. For this purpose, the user must set the corresponding parameter values on the corresponding AS-i slave and transmit them thereto. The parameterization of the AS-i slave 5 can be implemented by the user by way of an engineering tool 1. To this end, the engineering tool 1 must structure a communication link with the AS-i master 3. The engineering tool 1 can either be connected directly to the AS-i master 3 or connected to a superordinate component of the AS-i master 3. In the present exemplary embodiment, the engineering tool 1 is connected to the controller 2 by way of a first communication link 11 between the engineering tool 1 and the controller 2. The engineering tool 1 can thus send data and thus parameters to the controller 2 by way of the first communication link 11, whereupon the controller 2 can forward this data via the second communication link 12 to the AS-i master 3 so that this is available to the AS-i master 3.

The engineering tool 1 includes in particular a computer-implemented method, by which parameters of one or a number of AS-i slaves to be parameterized can be determined. The user can preferably determine the parameters of the AS-i slave to be parameterized by way of a programming interface. Since the parameters of the slave or slaves may have been determined, these can be transmitted to the AS-i master 3 (either directly or by way of interconnected devices).

In order to determine the parameters of the AS-i slave, the user can access stored parameters of different AS-i slaves by way of a data memory 14 of the engineering tool 1 so that a simplified parameterization of the AS-i slave to be parameterized can take place. The user must subsequently implement a query within the engineering tool 1 using the data memory 14 in order to determine whether the second AS-i slave 5 to be parameterized is stored in this data memory 14. If the second AS-i slave is stored in this data memory 14, a parameter set of the second AS-i slave 5 can be loaded from this data memory 14 by way of the engineering tool 1.

The parameter set of an AS-i slave includes in particular variable and/or fixed parameters of the AS-i slave. If only fixed parameters of the AS-i slave to be parameterized are available (in the present example of the second AS-i slave 5), no further inputs must take place by the user in order to determine the parameters of the AS-i slave to be parameterized since the parameters already display a unique non-changeable parameter value. The fixed parameters of a parameter set are thus already determined. If by contrast variable parameters are available, the user must define the variable parameters more precisely so that these are determined. Variable parameters can predetermine a value range for instance, in which a parameter value of an AS-i slave to be parameterized can lie. The system-specific parameter value must however be defined and thus determined firstly by the user. Similarly, a restriction in a value range by the user may be necessary for instance in order to determine the parameters.

The parameter set of the second AS-i slave 5 stored in the data memory 14 includes for instance variable and/or fixed parameters of the second AS-i slave 5. The user must subsequently define the variable parameters of the second AS-i slave 5, so that the parameters of the second AS-i slaves 5 are determined. The parameters can thus be transmitted to the AS-i master 3.

During parameterization by way of the data memory 14 of the engineering tool 1, the engineering tool 1 can access internal data. If the parameters of the AS-i slave to be parameterized are now not stored in the data memory 14 of the engineering tool 1 for instance, it is likewise conceivable that the parameters of the AS-i slave to be parameterized are loaded into the engineering tool 1 by way of a device description file 10. For this purpose, a slave-specific device description file 10, which contains a slave-specific parameter set, is loaded into the engineering tool 1. The loading of the device description file 10 into the engineering tool 1 can take place for instance by way of an external storage medium (memory card, USB stick etc.) or by way of the internet. Once a user has loaded the device description file 10 into the engineering tool 1, the parameter set of the AS-i slave to be parameterized is likewise available to the engineering tool 1, so that the user can determine the parameters of the AS-i slave to be parameterized. The parameter set of a device description file is defined in particular by the manufacturer so that an assignment of faulty parameters of the slave to be parameterized can be ruled out.

The parameter set of the AS-i slave to be parameterized thus facilitates the user with determining the parameter of the AS-i slave to be parameterized since the parameter set already prespecifies the fixed and variable parameters of the AS-i slave to be parameterized. The laborious manual inputting of the different parameters of the AS-i slave to be parameterized is thus omitted for the user.

If the user is not able either to load the parameter set of the AS-i slave to be parameterized from the data memory 14 or a device description file 10 into the engineering tool 1, it can likewise implement a manual inputting of the parameters of the AS-i slave to be parameterized in the engineering tool 1 so that the parameters of the AS-i slave to be parameterized are determined.

Once the parameters of the AS-i slave 5 to be parameterized have been determined by the user by way of the engineering tool 1, the parameters are transmitted to the AS-i master 3. The determined parameters are herewith sent to the AS-i master 3 at least by way of a first telegram. In the present instance, the determined parameters are firstly transmitted from the engineering tool 1 to the controller 2 and are transmitted herefrom by way of the first telegram by way of the second communication link to the AS-i master 3 and in particular the receive unit 7 thereof. The AS-i master 3 receives the first telegram with a receive unit 7. This first telegram contains the determined parameters of the slave 5 to be parameterized. In order to transmit the parameters from the controller 2 to the AS-i master 3, a communication cycle may be sufficient. It is however also conceivable for the determined parameters to be transmitted by way of the first telegram through several communication cycles between the controller 2 and the AS-i master 3. The term “telegram” is in particular not reduced to a communication cycle between the affected two devices. A telegram can likewise be transmitted by way of a number of communication cycles between the two devices. The first telegram (and thus the determined parameters) can thus be transmitted within a communication cycle or a number of communication cycles between the controller and the AS-i master.

The receive unit 7 of the AS-i master 3 receives the determined parameters of the AS-i slave 5 to be parameterized. An automatic conversion of the received first telegram thereupon takes place, said first telegram including the determined parameters of the AS-i slave 5 to be parameterized, into an AS-i telegram by a processing unit 8 of the AS-i master, so that the AS-i telegram contains the determined parameters of the AS-i slave 5 to be parameterized. The processing unit 8 thus extracts the determined parameters of the AS-i slave 5 to be parameterized from the first telegram and therefore provides that these parameters are sent to the AS-i slave 5 to be parameterized by way of an AS-i telegram. The send unit 9 thus sends the AS-i telegram provided by the processing unit 9, said AS-I telegram containing the determined parameters of the AS-i slave 5 to be parameterized, to the AS-i slave 5 to be a parameterized.

The AS-i slave 5 receives the AS-i telegram determined therefor and can parameterize itself by way of the determined parameters contained therein.

In order to parameterize an AS-i slave, parameters of the AS-i slave to be parameterized can thus be transmitted by way of a standardized communication link to the standardized receive unit 7 of the AS-i master 3 by way of an engineering tool 1. The AS-i master 3 can thus be provided with a standardized first telegram. The AS-i master 3 itself thereupon provides, by way of its processing unit 8, for the automatic conversion of the parameters contained in the first telegram into an AS-i telegram. The complex preparation of the AS-i telegrams, which has to be generated by the user in order to parameterize an AS-i slave itself, can thus be omitted. The outlay of the parameterization of an AS-i slave can thus be minimized. Furthermore, the probability of a faulty parameterization can also be reduced.

A further advantageous idea resides in the first telegram not only being able to transmit determined parameters of an AS-i slave 5 to the AS-i master 3, but instead the parameters of at least two AS-i slaves being able to be sent by way of the first telegram to the AS-i master 3. In the engineering tool 1, a determination of the parameters of the AS-i slave to be parameterized (e.g. second and third AS-i slave 5, 6) thus takes place first. These determined parameters of the AS-i slave 5, 6, to be parameterized are sent by way of the first telegram to the AS-i masters 3. The determined parameters can be transmitted for this purpose as a data packet in particular by way of a telegram. The AS-i master 3 receives the determined parameters of the AS-i slave 5, 6 to be parameterized by way of its receive unit 7 and thereupon converts the individual determined parameters of the AS-i slave 5, 6 to be parameterized by way of its processing unit 8 into a respective slave-specific AS-i telegram so that the AS-i slaves 5, 6 to be parameterized are each supplied with the parameters determined therefor in the engineering tool 1. By way of the engineering tool 1 a user can in this way send a data packet, which consists of a number of determined parameters of AS-i slaves 4, 5, 6 to be parameterized, in a step to the

AS-i master 3, whereupon the AS-i master 3 implements an automatic conversion into individual slave-specific AS-i telegrams.

A further advantageous idea resides in the AS-i master 3 and the controller 2 comprising a memory in each instance, in which they store the determined parameters of an AS-i slave 4, 5, 6 to be parameterized during an afore-described parameterization. After an initial parameterization of the AS-i slaves, the parameters of the parameterized AS-i slaves 4, 5, 6 are thus already known to the AS-i master 3 and/or controller 2. If one of these AS-i slaves 4, 5, 6 is now exchanged, no renewed parameterization of the AS-i slaves 4, 5, 6 has to take place by the user by way of the engineering tool 1, since the parameters of the relevant AS-i slaves 4, 5, 6 are already known to the AS-i master 3 and/or the controller 2. The AS-i master 3 and/or the controller 2 automatically sends the parameters stored in the memory to the exchanged AS-i slaves 4, 5, 6 so that this can set the corresponding parameters.

A further advantageous idea resides in the AS-i master 3 implementing a control of the parameters of an AS-i slave to be parameterized originating from the engineering tool 1 with the AS-i slave data of the AS-i slave to be parameterized and known to the AS-i master 3. If the AS-i master recognizes that the AS-i slave parameters sent by the engineering tool 1 do not correspond to the AS-i slave, this can output a fault message.

The advantage of the inventive parameterization resides in particular in the effort involved for a user in parameterizing an AS-i slave 4, 5, 6 being enormously reduced and the risk of a faulty parameterization being further significantly reduced. Since the user now does not need to write any specific program for transmitting the parameters, the effort for the user can be significantly minimized. The user only needs to select the AS-i slave 4, 5, 6 to be parameterized in the engineering tool 1 and determine the parameters. Dependencies between the parameters can already be taken into account in the engineering tool, so that a faulty configuration of the AS-i slave 4, 5, 6 can be avoided.

1. A method for parameterizing an AS-i slave, comprising:
determining the parameters of the AS-i slave to be parameterized via an engineering tool;
transmitting the determined parameters to an AS-i master by way of a first telegram, which is not an AS-I telegram;
receiving the first telegram, containing the determined parameters of the AS-i slave to be parameterized, via a receive unit of the AS-i master;
automatically converting the received first telegram into an AS-i telegram via a processing unit of the AS-i master so that the AS-i telegram contains the determined parameters of the AS-i slave to be parameterized; and
sending the AS-telegram, which contains the determined parameters of the AS-i slave to be parameterized, to the AS-i slave to be parameterized via a send unit of the AS-i master,
wherein in order to determine the parameters of the AS-i slave to be parameterized via the engineering tool, a device description file of the slave to be parameterized is loaded, wherein the device description file includes a parameter set of the AS-i slave to be parameterized.

2. The method of claim 1, wherein the parameters of an AS-i slave to be parameterized to be transmitted comprise a data size of greater than 4 bits.

3. The method of claim 1, wherein the AS-i slave to be parameterized receives the AS-i telegram and parameterizes itself by way of the determined parameters of the received AS-i telegram.

4. The method of claim 1, wherein, in order to determine the parameters of the AS-i slave to be parameterized, a parameter set of the AS-i slave to be parameterized is loaded by way of the engineering tool.

5. The method of claim 4, wherein parameter sets of different AS-slaves are stored in the engineering tool, wherein the loaded parameter set is a parameter set of the stored parameter sets.

6. The method of claim 5, wherein the loaded parameter set of the AS-i slave to be parameterized is modified via the engineering tool in order to determine the parameters of the AS-i slave to be parameterized.

7. The method of claim 1, wherein the AS-i slave outputs a fault signal, provided the determined parameters transmitted by the AS-i telegram are faulty.

8. The method of claim 1, wherein the determined parameters of the AS-i slave are stored in the AS-i master.

9. The method of claim 1, wherein the AS-i master checks whether the received parameters of the AS-i slave to be parameterized correspond to the AS-i slave to be parameterized and connected to the AS-i master.

10. The method of claim 1, wherein parameters of at least two AS-i slaves to be parameterized are determined by way of the engineering tool and the determined parameters of the at least two AS-i slaves to be parameterized are transmitted by way of the first telegram to the AS-i master Wand thereupon the processing unit of the AS-i master converts the received first telegram automatically into an AS-i telegram for the respective AS-i slave to be parameterized so that the respective AS-i telegram contains the determined parameters of the AS-i slave to be parameterized, and wherein the send unit of the AS-i master transmits the AS-i telegram to the at least two slaves to be parameterized, the AS-i telegram containing the determined parameters of the respective AS-i slave.

11. An AS-i master, comprising:
a receive unit, configured to receive a first telegram; including parameters for an AS-i slave to be parameterized, the first telegram not being an AS-i telegram;
a processing unit, configured to automatically convert the received first telegram into an AS-i telegram, so that the AS-i telegram contains the parameters of the AS-i slave to be parameterized; and
a send unit, configured to send the AS-i telegram, including the parameters of the AS-i slave to be parameterized, to the AS-i slave to be parameterized,
wherein the AS-i master is configured to check if the received parameters of the AS-I slave to be parameterized correspond to the AS-I slave to be parameterized.

12. The AS-i master of claim 11, wherein the AS-i master including the receive unit is configured to receive a first telegram, including parameters for at least two AS-i slave to be parameterized, is configured to automatically convert the received first telegram into an AS-i telegram for the respective AS-i slave to be converted so that the respective AS-i telegram includes the determined parameters of the AS-i slave to be parameterized.

13. A system, comprising:
an engineering tool; and
the AS-i master of claim 11, wherein the engineering tool is embodied such that parameters of the AS-i slave to be parameterized are determinable via the engineering tool and are transmittable via a first telegram to the AS-i master wherein a device description file of the slave to be parameterized is loaded in order to determine the parameters of the AS-i slave to be parameterized, via the engineering tool, and wherein the device description file includes a parameter set of the AS-i slave to be parameterized.

14. (canceled)

15. The method of claim 2, wherein, in order to determine the parameters of the AS-i slave to be parameterized, a parameter set of the AS-i slave to be parameterized is loaded by way of the engineering tool.

16. The method of claim 15, wherein parameter sets of different AS-slaves are stored in the engineering tool, wherein the loaded parameter set is a parameter set of the stored parameter sets.

17. The method of claim 16, wherein the loaded parameter set of the AS-i slave to be parameterized is modified via the engineering tool in order to determine the parameters of the AS-i slave to be parameterized.

18. A system, comprising:
an engineering tool; and
the AS-i master of claim 12, wherein the engineering tool is embodied such that parameters of the AS-i slave to be parameterized are determinable via the engineering tool and are transmittable via a first telegram to the AS-i master wherein a device description file of the slave to be parameterized is loaded in order to determine the parameters of the AS-i slave to be parameterized, via the engineering tool, and wherein the device description file includes a parameter set of the AS-i slave to be parameterized.
